(19) United States
(12) Patent Application Publication
(10) Pub. No.: US 2025/0299345 A1
(43) Pub. Date: Sep. 25, 2025

(54) INTEGRATED TRAJECTORY ESTIMATION METHOD AND SYSTEM BASED ON GENERATIVE MODEL

(71) Applicant: GWANGJU INSTITUTE OF SCIENCE AND TECHNOLOGY, Gwangju (KR)

(72) Inventors: Hae Gon JEON, Gwangju (KR); In Hwan Bae, Gwangju (KR); Young Jae Park, Gwangju (KR)

(73) Assignee: GWANGJU INSTITUTE OF SCIENCE AND TECHNOLOGY, Gwangju (KR)

(21) Appl. No.: 18/982,956

(22) Filed: Dec. 16, 2024

(30) Foreign Application Priority Data
Mar. 19, 2024 (KR) 10-2024-0037757

(51) Int. Cl. G06T 7/246

(52) U.S. Cl. CPC G06T 7/251; G06T 2207/20081; G06T 2207/30241

(57) ABSTRACT

An integrated trajectory estimation model learning method is provided. The method includes receiving a plurality of position coordinates according to a movement of a pedestrian, generating a movement trajectory set related to a movement trajectory of the pedestrian based on the plurality of position coordinates, defining a singular space having a singular space coordinate system based on the movement trajectory set, and calculating a movement pattern of the pedestrian corresponding to the movement trajectory set on the singular space, and training the trajectory estimation model by using the movement pattern to estimate a future movement trajectory from a past movement trajectory of an arbitrary pedestrian.

### CROSS REFERENCE TO RELATED APPLICATION

The present application claims priority to Korean Patent Application No. 10-2024-0037757, filed on Mar. 19, 2024, the entire content of which is incorporated herein for all purposes by this reference.

### BACKGROUND

### Field of the Invention

The present invention relates to an integrated trajectory estimation method and system based on a generative model.

### DESCRIPTION OF GOVERNMENT-SPONSORED RESEARCH

The present invention was carried out with support from the national research and development project, with the unique project identification number being 1711193897 and the project number being 2019-0-01842-005. The project related to the present invention is supervised by the Ministry of Science and ICT, and managed by the Institute of Information and Communications Technology Planning and Evaluation (IITP). The research program is titled “ICT Broadcasting Innovation Talent Development Project,” and the research project is named “Support for AI Graduate Schools (GIST).” The project executing institution is Gwangju Institute of Science and Technology, and the research period is from Jan. 1, 2023, to Dec. 31, 2023.

In addition, the present invention was carried out with support from the national research and development project, with the unique project identification number being 1711196775 and the project number being S1602-20-1001. The project related to the present invention is supervised by the Ministry of Science and ICT, and managed by the National IT Industry Promotion Agency (NIPA). The research program is titled “AI-Centered Industrial Convergence Cluster Development (R&D) Project,” and the research project is named “Development of Customized Autonomous Driving Software Platform Technology for Specific-Purpose Vehicles.” The project executing institution is Autonomous a2z Co., Ltd., and the research period is from Jan. 1, 2023, to Dec. 31, 2023.

In addition, the present invention was carried out with support from the national research and development project, with the unique project identification number being 1711197190 and the project number being 2022-DD-UP-0312-02. The project related to the present invention is supervised by the Ministry of Science and ICT, and managed by (Foundation) the Korea Innovation Foundation (INNOPOLIS). The research program is titled “Regional Research and Development Innovation Support Project,” and the research project is named “Convergent Cultural Virtual Studio for AI-Based Metaverse Implementation.” The project executing institution is Gwangju Institute of Science and Technology, and the research period is from Jan. 1, 2023, to Dec. 31, 2023.

In addition, the present invention was carried out with support from the national research and development project, with the unique project identification number being 1711139517 and the project number being 2021-0-02068-001. The project related to the present invention is supervised by the Ministry of Science and ICT, and managed by the Institute of Information and Communications Technology Planning and Evaluation (IITP). The research program is titled “ICT Broadcasting Innovation Talent Development Project (R&D),” and the research project is named “Research and Development of AI Innovation Hub.” The project executing institution is Korea University, and the research period is from Jul. 1, 2021, to Dec. 31, 2023.

### DESCRIPTION OF THE RELATED ART

Recently, extensive research has been conducted on methods for estimating a movement trajectory of a pedestrian in various application fields such as crowd simulation, social robot navigation, obstacle avoidance, security and surveillance systems, or the like based on computer vision.

The estimation of the movement trajectory infers a future movement trajectory of the pedestrian based on the values of position coordinates sequentially measured as the pedestrian moves.

For example, the trajectory estimation model can be implemented based on various estimation methods such as stochastic prediction, deterministic prediction, momentary observation, domain adaptation, and few-shot learning.

These conventional trajectory estimation models define elements such as a length of an input trajectory, data division, and preprocessing process differently depending on each estimation method, and conventionally, in order to improve the learning performance of the trajectory estimation model, an architecture design optimized for each estimation method is required.

### SUMMARY

The present invention relates to a method and system for training an integrated trajectory estimation model based on a generative model, and an integrated trajectory estimation method and system using the same.

In addition, the present invention relates to an integrated trajectory estimation method and system that considers a flow of a trajectory along which a pedestrian actually walks and trains a trajectory estimation model based on the flow of the trajectory so as to more accurately estimate a future movement trajectory of the pedestrian from a past movement trajectory of the pedestrian.

In addition, the present invention relates to an integrated trajectory estimation method and system that can integrate and prepare training data for trajectory estimation models of different types and train a trajectory estimation model so as to estimate accurate future movement trajectories for movement trajectories of pedestrians measured in various formats.

In order to achieve objects described above, according to an aspect of the present invention, an integrated trajectory estimation system includes: receiving a plurality of position coordinates according to a movement of a pedestrian; generating a past movement trajectory of the pedestrian based on the plurality of position coordinates; and estimating a future movement trajectory corresponding to the past movement trajectory using a pre-trained trajectory estimation model, in which the pre-trained trajectory estimation model is trained according to an integrated trajectory estimation model learning method, and the integrated trajectory estimation model learning method includes receiving a plurality of learning position coordinates according to the movement of the pedestrian, generating a movement trajectory set related to a learning movement trajectory of the pedestrian based on the plurality of learning position coordinates, defining a singular space having a singular space coordinate system based on the movement trajectory set, and calculating a movement pattern of the pedestrian corresponding to the movement trajectory set on the singular space, and training the trajectory estimation model by using the movement pattern calculated based on the singular space to estimate the future movement trajectory from the past movement trajectory of an arbitrary pedestrian.

According to another aspect of the present invention, an integrated trajectory estimation system includes: an input unit configured to receive a plurality of position coordinates according to a movement of a pedestrian; and a control unit configured to generate a past movement trajectory of the pedestrian based on the plurality of position coordinates and estimate a future movement trajectory corresponding to the past movement trajectory using a pre-trained trajectory estimation model, in which the pre-trained trajectory estimation model is trained according to an integrated trajectory estimation model learning method, and the integrated trajectory estimation model learning method includes receiving a plurality of learning position coordinates according to the movement of the pedestrian, generating a movement trajectory set related to a learning movement trajectory of the pedestrian based on the plurality of learning position coordinates, defining a singular space having a singular space coordinate system based on the movement trajectory set, and calculating a movement pattern of the pedestrian corresponding to the movement trajectory set on the singular space, and training the trajectory estimation model by using the movement pattern calculated based on the singular space to estimate the future movement trajectory from the past movement trajectory of an arbitrary pedestrian.

According to still another aspect of the present invention, a program stored on a computer-readable recording medium and executed by one or more processors in an electronic device, includes instructions to execute: receiving a plurality of position coordinates according to a movement of a pedestrian; generating a past movement trajectory of the pedestrian based on the plurality of position coordinates; and estimating a future movement trajectory corresponding to the past movement trajectory using a pre-trained trajectory estimation model, in which the pre-trained trajectory estimation model is trained according to an integrated trajectory estimation model learning method, and the integrated trajectory estimation model learning method includes receiving a plurality of learning position coordinates according to the movement of the pedestrian, generating a movement trajectory set related to a learning movement trajectory of the pedestrian based on the plurality of learning position coordinates, defining a singular space having a singular space coordinate system based on the movement trajectory set, and calculating a movement pattern of the pedestrian corresponding to the movement trajectory set on the singular space, and training the trajectory estimation model by using the movement pattern calculated based on the singular space to estimate the future movement trajectory from the past movement trajectory of an arbitrary pedestrian.

According to still another aspect of the present invention, an integrated trajectory estimation model learning method includes: receiving a plurality of position coordinates according to a movement of a pedestrian; generating a movement trajectory set related to a movement trajectory of the pedestrian based on the plurality of position coordinates; defining a singular space having a singular space coordinate system based on the movement trajectory set, and calculating a movement pattern of the pedestrian corresponding to the movement trajectory set on the singular space; and training the trajectory estimation model by using the movement pattern calculated based on the singular space to estimate a future movement trajectory from a past movement trajectory of an arbitrary pedestrian.

According to still another aspect of the present invention, an integrated trajectory estimation model learning system includes: an input unit configured to receive a plurality of position coordinates according to a movement of a pedestrian; and a control unit configured to train a trajectory estimation model to estimate a future movement trajectory from a past movement trajectory of an arbitrary pedestrian based on the plurality of position coordinates, in which the control unit generates a movement trajectory set related to the movement trajectory of the pedestrian based on the plurality of position coordinates, defines a singular space having a singular space coordinate system based on the movement trajectory set, calculates a movement pattern of the pedestrian corresponding to the movement trajectory set on the singular space, and trains the trajectory estimation model using the movement pattern calculated based on the singular space.

According to still another aspect of the present invention, a program stored on a computer-readable recording medium and executed by one or more processors in an electronic device, includes instructions to execute: receiving a plurality of position coordinates according to a movement of a pedestrian; generating a movement trajectory set related to a movement trajectory of the pedestrian based on the plurality of position coordinates, defining a singular space having a singular space coordinate system based on the movement trajectory set, and calculating a movement pattern of the pedestrian corresponding to the movement trajectory set on the singular space, and training the trajectory estimation model by using the movement pattern calculated based on the singular space to estimate a future movement trajectory from a past movement trajectory of an arbitrary pedestrian.

According to various embodiments of the present invention, the integrated trajectory estimation method and system based on a generative model calculate the movement pattern for the motion of the pedestrian based on the movement trajectory of the pedestrian, and train the trajectory estimation model using the calculated movement pattern. Accordingly, by considering the flow of a trajectory that the pedestrian actually walks, and based on the flow of the trajectory, it is possible to more accurately estimate the future movement trajectory of the pedestrian from the past movement trajectory of the pedestrian.

In addition, according to various embodiments of the present invention, the integrated trajectory estimation method and system based on the generative model project the movement trajectory of the pedestrian onto the singular space to integrate the movement trajectories of the pedestrian collected in different types into the singular space, and trains the trajectory estimation model based on the integrated singular space. Therefore, it is possible to include training data for the different types of trajectory estimation models in an integrated manner, and estimate accurate the future movement trajectory for the movement trajectory of the pedestrian measured in various types.

### BRIEF DESCRIPTION OF THE DRAWINGS

FIG. 1 illustrates one embodiment of an integrated trajectory estimation model learning system according to the present invention.

FIG. 2 illustrates an integrated trajectory estimation model learning system according to the present invention.

FIG. 3 illustrates one embodiment of applying an adaptive anchor.

FIG. 4 illustrates one embodiment of a future movement trajectory estimated according to a diffusion step.

FIG. 5 is a flowchart illustrating an integrated trajectory estimation model learning method according to the present invention.

FIG. 6 is a flowchart illustrating a step of generating a movement trajectory set of FIG. 5.

FIG. 7 is a flowchart illustrating a step of calculating a movement pattern of FIG. 5.

FIG. 8 illustrates one embodiment of defining a singular space.

FIG. 9 and FIG. 10 illustrate one embodiment of calculating a movement pattern.

FIG. 11 illustrates one embodiment of different movement patterns.

FIG. 12 illustrates one embodiment of training a trajectory estimation model.

### DETAILED DESCRIPTION OF EMBODIMENTS

Hereinafter, embodiments disclosed in the present specification will be described in detail with reference to the attached drawings, and identical or similar components will be given the same reference numerals regardless of the drawing symbols, and redundant descriptions thereof will be omitted. The suffixes “module” and “unit” used for components in the following description are given or used interchangeably only for the convenience of writing the specification, and do not have distinct meanings or roles in themselves. In addition, in a case of describing the embodiments disclosed in the present specification, when it is determined that a specific description of a related known technology may obscure the gist of the embodiments disclosed in the present specification, the detailed description thereof will be omitted. In addition, the attached drawings are only intended to facilitate easy understanding of the embodiments disclosed in the present specification, and the technical ideas disclosed in the present specification are not limited by the attached drawings, and should be understood to include all modifications, equivalents, or substitutes included in the spirit and technical scope of the present invention.

Terms including ordinal numbers such as first, second, or the like may be used to describe various components, but the components are not limited by the terms. The terms are used only for the purpose of distinguishing one component from another.

When a component is referred to as being “connected” or “connected” to another component, it should be understood that it may be directly connected or connected to that other component, but there may also be other components in between. Meanwhile, when a component is referred to as being “directly connected” or “directly connected” to another component, it should be understood that there are no other components therebetween.

The singular expression includes the plural expression unless the context clearly indicates otherwise.

In this application, the terms “include” or “have” are intended to specify the presence of features, numbers, steps, operations, components, parts, or combinations thereof described in the specification, but should be understood not to preclude the possibility of the presence or addition of one or more other features, numbers, steps, operations, components, parts, or combinations thereof.

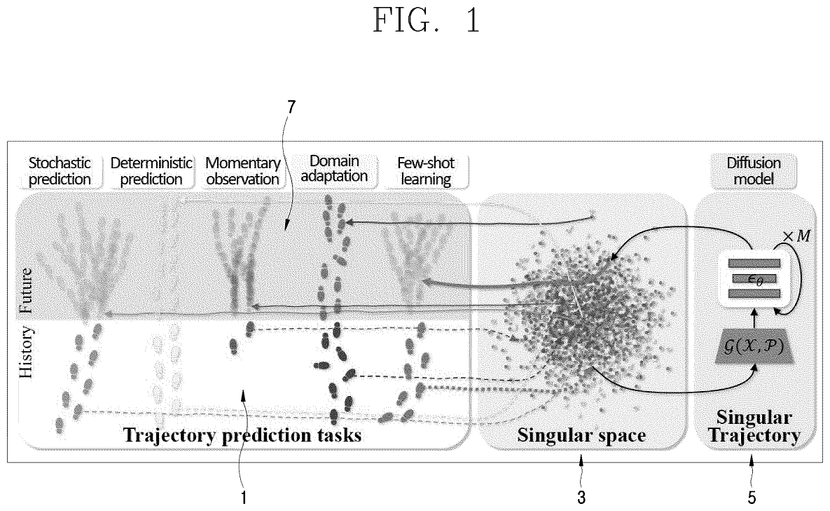

FIG. 1 illustrates one embodiment of an integrated trajectory estimation model learning system according to the present invention.

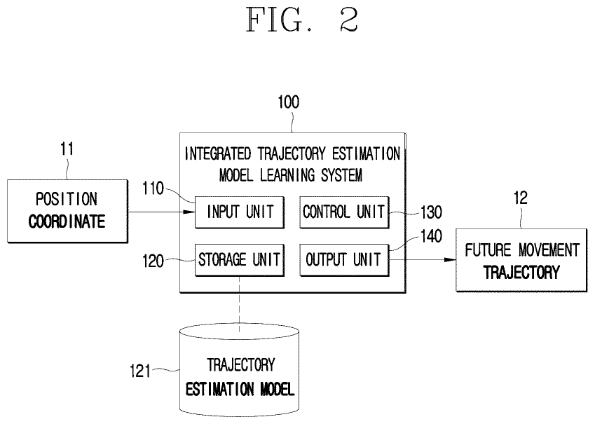

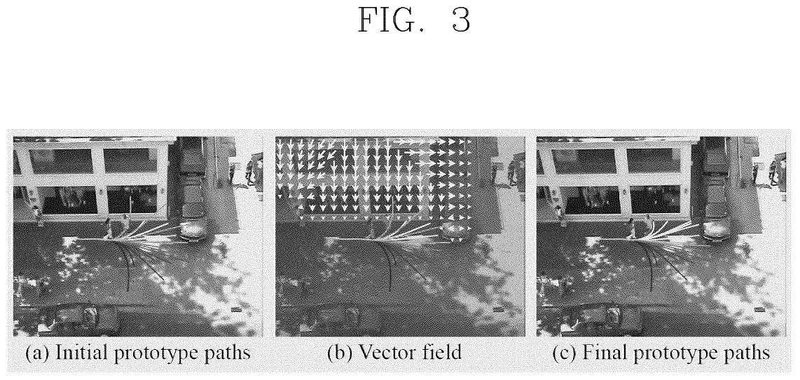

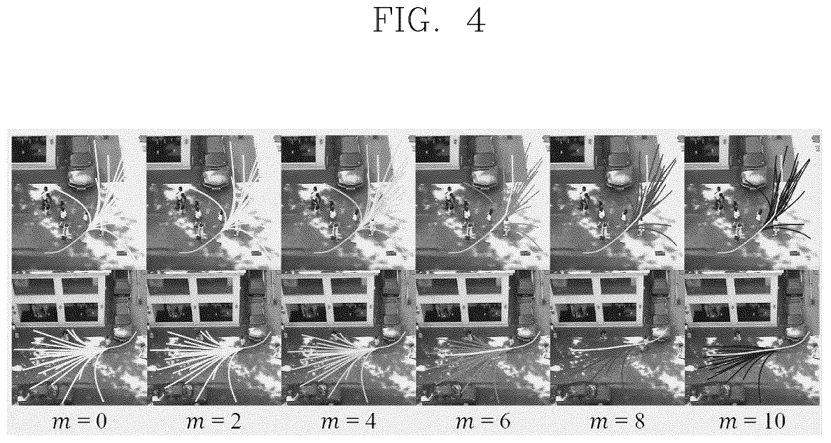

FIG. 2 illustrates an integrated trajectory estimation model learning system according to the present invention, FIG. 3 illustrates one embodiment of applying an adaptive anchor. FIG. 4 illustrates one embodiment of a future movement trajectory estimated according to a diffusion step.

An integrated trajectory estimation system according to the present invention may generate a past movement trajectory of a pedestrian based on a plurality of position coordinates according to the movement of the pedestrian, and estimate a future movement trajectory corresponding to a past movement trajectory generated in advance using a pre-trained trajectory estimation model.

To this end, referring to FIG. 1, the integrated trajectory estimation model learning system according to the present invention may generate a movement trajectory set related to a movement trajectory 1 of the pedestrian based on the plurality of position coordinates according to the movement of the pedestrian, and may calculate the movement pattern of the pedestrian corresponding to the movement trajectory set using a singular space 3 defined based on the movement trajectory set.

Through this, the integrated trajectory estimation model learning system may train the trajectory estimation model 5 to estimate the future movement trajectory 7 from the movement trajectory 1 of the pedestrian based on the previously calculated movement pattern.

Here, the plurality of position coordinates according to the movement of the pedestrian may include the position coordinate of the pedestrian collected based on a series of orders, and the movement trajectory 1 of the pedestrian may be a trajectory along which the pedestrian moved and may be a list of the plurality of position coordinates according to a series of orders.

For example, the plurality of position coordinates may include the position coordinates of the pedestrian extracted from each of the plurality of images based on time series data. In this case, the movement trajectory 1 may be a list of the position coordinates of the pedestrian extracted from the image according to the time series data.

In this case, the plurality of position coordinates may be extracted from each of the plurality of images belonging to a predetermined time interval based on the time series data.

In addition, the image from which the position coordinates of the pedestrian are extracted may include a plurality of pedestrians, and in this case, the integrated trajectory estimation model learning system may receive a plurality of position coordinates corresponding to each of the plurality of pedestrians and use the plurality of position coordinates to generate a plurality of movement trajectories 1 for each of the plurality of pedestrians.

As another example, the plurality of position coordinates may include the position coordinates of the pedestrian extracted from each of a plurality of frames included in a specific video. In this case, the movement trajectory 1 may be a list of the position coordinates of the pedestrian extracted from each frame according to a frame order.

In this case, the plurality of position coordinates may be extracted from each of the plurality of frames corresponding to a predetermined number of frames.

Meanwhile, the movement trajectory set includes information on the movement trajectory 1 of the pedestrian, and may include, for example, a plurality of unit movement trajectories obtained by dividing the movement trajectory 1 that lists the plurality of position coordinates.

In this case, depending on the embodiment, the unit movement trajectory may be obtained by dividing the movement trajectory 1 based on a predetermined unit time, or may be obtained by dividing the movement trajectory 1 into a predetermined number.

The singular space 3 may be a space including a singular space coordinate system, and this singular space 3 may be defined using a singular vector calculated through a singular value decomposition (SVD) for the movement trajectory set.

That is, the singular vector may be obtained by performing singular value decomposition on the movement trajectory set according to the following Mathematical Expression 1.

$$A = U \sum {V}^{T} \qquad [ Mathematical Expression 1 ]$$

Here, A may be the movement trajectory set, U and V^{T} may be singular vectors for the movement trajectory set, and Σ may be a diagonal matrix having singular values for the movement trajectory set.

In this case, U may be a first singular vector having the eigenvector of A×A^{T} as a column, and V^{T} may be a second singular vector having the eigenvector of A^{T}×A as a column.

At this time, the integrated trajectory estimation model learning system may extract a predetermined number (for example, 4) of singular values from the diagonal matrix having the singular values calculated based on Mathematical Expression 1, and in this case, the size (for example, the number of rows and columns) of the singular vector can be adjusted to correspond to the number of previously extracted singular values.

In this regard, the integrated trajectory estimation model learning system may utilize singular values suitable for representing the movement trajectory 1 of the pedestrian by removing noise and singular values corresponding to duplicate values from the diagonal matrix.

Accordingly, elements related to the movement trajectory set and the singular vector may be expressed as in the following Mathematical Expression 2.

$$A ∈ {R}^{L \times ( 2 \times {T}_{win} )} \qquad [ Mathematical Expression 2 ]$$

$${U}_{k} ∈ {R}^{L \times K}$$

$${\sum }_{K} ∈ {R}^{K \times K}$$

$${V}_{K}^{T} ∈ {R}^{K \times ( 2 \times {T}_{win} )}$$

Here, A may be the movement trajectory set, L may be the number of unit movement trajectories included in the movement trajectory set, T_{win} may be the length of the unit movement trajectory, and K may be the number of singular values extracted from the diagonal matrix.

In addition, U_{K} may be the first singular vector whose size is adjusted by extracting K (for example, 4) singular values from in Mathematical Expression 1, Σ_{K} may be the diagonal matrix having the K singular values, and V_{K}^{T} may be the second singular vector whose size is adjusted based on the K singular values.

In this case, V_{K}^{T} may be a movement pattern set representing K representative movement patterns for the pedestrian, and each movement pattern may be represented as V_{K}^{T}∈R^{2×T}^{_{win}}.

In relation to this, each movement pattern may be understood as being orthogonal to each other, and accordingly, the singular space 3 can be defined as in the following Mathematical Expression 3 using the singular vector based on the K singular values.

$$A = {U}_{K} \cdot {\sum }_{K} ∈ {R}^{L \times K} \qquad [ Mathematical Expression 3 ]$$

Here, A represents the coordinates of the movement trajectory set in the singular space 3, and may mean a movement pattern calculated by projecting the movement trajectory set onto the singular space 3. This can also be represented as in the following Mathematical Expression 4.

$$A = A \times {( {V}_{K}^{T} )}^{- 1} = A \times {V}_{K} \qquad [ Mathematical Expression 4 ]$$

As described above, the integrated trajectory estimation model learning system performs singular value decomposition on the movement trajectory set, extracts a predetermined number of singular values from among the singular values according to the singular value decomposition, calculates a singular vector corresponding to the extracted singular value, and projects the movement trajectory set onto the singular space 3 using the calculated singular vector, thereby calculating the movement pattern related to the movement trajectory 1 of the pedestrian.

That is, the movement pattern may be generated based on the trajectory along which the pedestrian moves to specify the direction (or motion) in which the pedestrian can move, and the integrated trajectory estimation model learning system may represent the movement trajectory 1 of the pedestrian based on the movement pattern based on the singular space 3, thereby indicating the movement trajectory 1 of different pedestrians as similar (or identical) movement patterns.

In this regard, the integrated trajectory estimation model learning system may generate the movement pattern for the movement trajectory set that includes the unit movement trajectories divided into different lengths according to the plurality of position coordinates (or input/output data types of the trajectory estimation model) according to the movement of the pedestrian.

To this end, the integrated trajectory estimation model learning system may interpolate the previously calculated movement pattern as in the following Mathematical Expression 5.

$${v}_{k} ∈ {R}^{2 \times {T}_{win}} \qquad [ Mathematical Expression 5 ]$$

$$\to {v}_{x , k} ∈ {R}^{2 \times {T}_{hist}}$$

Here, vₖ may be the previously calculated movement pattern, Tₕᵢₛₜ may be the length of a unit movement trajectory different from T_{win} which is the length of the previously used unit movement trajectory, and v_{x,k} may be obtained by interpolating the previously calculated movement pattern according to the length of the unit movement trajectory according to Tₕᵢₛₜ.

In this regard, an integrated trajectory estimation model learning system 100 may generate a transformation matrix according to Irwin-Hall distribution based on Cardinal B-splines for a movement pattern that appears in the form of a two-dimensional curve.

In this case, the previously generated transformation matrix can be expressed as in the Mathematical Expression 6 below.

$${C}_{{T}_{hist}} ∈ {R}^{( 2 \times {T}_{hist} ) \times ( 2 \times {T}_{win} )} \qquad [ Mathematical Expression 6 ]$$

Here, C_{T}_{ₕᵢₛₜ} may be a transformation matrix, and this transformation matrix may be calculated in the form of a constant having different values depending on the length of the unit movement trajectory.

Therefore, the integrated trajectory estimation model learning system may approximate the movement patterns corresponding to the unit movement trajectories having different lengths by using the transformation matrix and the previously calculated movement pattern, as in the following Mathematical Expression 7, and may calculate the movement pattern by projecting the movement trajectory set including the unit movement trajectories of different lengths onto the singular space 3.

$${v}_{x , k} = {C}_{{T}_{hist}} \times {v}_{k} \qquad [ Mathematical Expression 7 ]$$

$$X = X \times {C}_{{T}_{hist}} \times {V}_{k}$$

$$X ∈ {R}^{N \times ( 2 \times {T}_{hist} )}$$

X∈R^{N×(2×T}^{ₕᵢₛₜ}⁾ Here, X may be the movement pattern calculated based on the unit movement trajectories of different lengths, and X may be the movement trajectory set including the unit movement trajectories of different lengths.

As described above, the integrated trajectory estimation model learning system may integrate the movement trajectories 1 of the pedestrians collected in different types into the singular space 3 by performing approximation between the movement trajectory sets including the unit movement trajectories of different lengths to calculate the movement pattern in the singular space 3, and by utilizing this, may accurately estimate the future movement trajectories 7 for various types of movement trajectories 1 through various trajectory estimation models trained based on the singular space 3.

Furthermore, the integrated trajectory estimation model learning system may train the trajectory estimation model 5 using the movement pattern calculated based on the singular space 3.

Here, the trajectory estimation model 5 may be implemented to estimate the future movement trajectory 7 based on the input past movement trajectory 1 for the pedestrian when the past movement trajectory 1 for the pedestrian is input.

Therefore, the integrated trajectory estimation model learning system may train the trajectory estimation model 5 using the previously calculated movement pattern to estimate the future movement trajectory 7 of the pedestrian from a predetermined noise distribution using the movement pattern calculated by the singular space 3.

In this regard, the trajectory estimation model 5 may be implemented in various forms. For example, the trajectory estimation model 5 may be implemented to perform stochastic prediction for the movement trajectory 1 of the pedestrian. In this case, the trajectory estimation model 5 may be trained to predict the plurality of future movement trajectories 7 based on the movement trajectory 1 of the pedestrian measured from a plurality of frames (for example, 8 frames).

For another example, the trajectory estimation model 5 may be implemented to perform deterministic prediction on the movement trajectory 1 of the pedestrian. In this case, the trajectory estimation model 5 may be trained to predict a specific future movement trajectory 7 based on the movement trajectory 1 of the pedestrian measured from the plurality of frames.

For another example, the trajectory estimation model 5 may be implemented to estimate the future movement trajectory 7 based on momentary observation on the movement trajectory 1 of the pedestrian. In this case, the trajectory estimation model 5 may be trained to predict the plurality of future movement trajectories 7 based on the movement trajectory 1 of the pedestrian measured from a relatively small number of frames (for example, two frames).

For another example, the trajectory estimation model 5 may be implemented to enable domain adaptation. Specifically, the trajectory estimation model 5 may be trained to estimate the future movement trajectory 7 in a specific space (or place) based on the movement trajectory 1 of the pedestrian in that space, and may be implemented to estimate the future movement trajectory 7 based on the movement trajectory 1 of the pedestrian in another specific space using the trained trajectory estimation model 5.

For another example, the trajectory estimation model 5 may be implemented to enable few-shot learning. In this case, the trajectory estimation model 5 may be pre-trained to estimate the future movement trajectory 7 from a predetermined past movement trajectory 1, and may be implemented to correct the parameter of the pre-trained trajectory estimation model 5 based on training data related to the movement trajectories 1 of different pedestrians.

Meanwhile, the trajectory estimation model 5 may be implemented to estimate the walking area in which the pedestrian can move in a predetermined image based on an adaptive anchor, and to represent the movement trajectory 1 (or, future movement trajectory 7) of the pedestrian based on the estimated walking area.

In this case, the image may be an image (or, video) from which the plurality of position coordinates received for the pedestrian are extracted.

Therefore, the trajectory estimation model 5 can be implemented to estimate the walking area from an image using a pre-equipped semantic segmentation model and move the movement trajectory of the pedestrian to an adjacent walking area based on a vector field corresponding to the image.

In this regard, referring to FIG. 2, the vector field corresponding to an image can be confirmed based on the semantic segmentation. In this case, the vector field may include a plurality of vectors from each position (or pixel) on the image toward the nearest walking area, and through this, the trajectory estimation model may be implemented to move the movement trajectory (for example, initial prototype paths) of the pedestrian to the adjacent walking area, thereby generating the movement trajectory (for example, final prototype paths) on which the adaptive anchor is performed.

Meanwhile, in one embodiment, the trajectory estimation model may be implemented to perform adaptive anchoring on the movement trajectory of the pedestrian based on the following Mathematical Expression 8.

$${P}_{S}^{′} = {P}_{S} + \vec{{F}_{I}} ( {P}_{S} {V}_{K}^{T} {C}_{{T}_{fut}}^{- 1} ) \qquad [ Mathematical Expression 8 ]$$

Here, P_{S} may be the movement trajectory for the pedestrian, P's may be the movement trajectory on which adaptive anchoring is performed, \vec{Fₗ} may be the vector field for the image, and C_{T}_{_{fut}}⁻¹ may be an inverse matrix of the transformation matrix corresponding to the unit movement trajectory having a length of T_{fut}.

In addition, the trajectory estimation model may be trained based on a diffusion model. That is, the trajectory estimation model may estimate the future movement trajectory corresponding to the movement trajectory of the pedestrian by diffusing the movement pattern according to the movement trajectory set for the pedestrian using the diffusion model.

Therefore, the trajectory estimation model may be implemented to input predetermined information related to the movement trajectory of the pedestrian into the diffusion model based on the following Mathematical Expression 9, and output the future movement trajectory corresponding to it.

$${ε}_{θ} ( {y}_{m} , m , X , P , G ) \qquad [ Mathematical Expression 9 ]$$

$$\hat{Y} = P + p ( {Y}_{M} ) {\prod }_{m = 1}^{M} {p}_{θ} ( {y}_{m - 1} \vert {y}_{m} )$$

Here, Ee may be the diffusion model, yₘ is a noise vector input to the diffusion model, m may mean a diffusion step of the diffusion model, and G may represent an interaction between the past movement trajectory (for example, X) of the pedestrian and the movement trajectory (for example, P) on which adaptive anchoring is performed.

In addition, Ŷ may be the future movement trajectory of the pedestrian, and p_{θ} may mean a distribution (for example, Gaussian distribution) used in the diffusion function.

In relation to this, referring to FIG. 4, the plurality of future movement trajectories estimated from the past movement trajectory can be confirmed according to different diffusion steps.

In this way, the integrated trajectory estimation system according to the present invention may receive the plurality of position coordinates according to the movement of the pedestrian, generate the past movement trajectory of the pedestrian based on the plurality of received position coordinates, and estimate the future movement trajectory corresponding to the previously generated past movement trajectory using the pre-trained trajectory estimation model.

In this case, the integrated trajectory estimation system may receive the plurality of images, receive the plurality of position coordinates according to the movement of the pedestrian from the plurality of images, and may obtain the future movement trajectory anchored to an area corresponding to the walking area in the previously received image through the adaptive anchor implemented in the trajectory estimation model.

Meanwhile, referring to FIG. 2, the integrated trajectory estimation model learning system 100 according to the present invention can include an input unit 110, a storage unit 120, a control unit 130, and an output unit 140.

The input unit 110 may be connected to a predetermined server or other device through a wireless or wired network, and may receive the plurality of position coordinates 11 for the pedestrian from the connected server or other device.

At this time, the input unit 110 may be connected to a server or other device where a predetermined image (or video) is stored via a wireless or wired network, and in this case, may receive the predetermined image (or video) from the previously connected server or other device, and extract the position coordinate 11 for the pedestrian from the received image.

The storage unit 120 may store instructions and data required for the operation of the integrated trajectory estimation model learning system 100 according to the present invention.

For example, the storage unit 120 may store a trajectory estimation model 121, a movement trajectory set generated based on the plurality of position coordinates 11, and a future movement trajectory 12 according to the movement trajectory set.

The control unit 130 may control the overall operation of the integrated trajectory estimation model learning system 100 according to the present invention.

For example, the control unit 130 may receive the plurality of position coordinates 11, generate the movement trajectory set for the pedestrian based on the plurality of position coordinates 11, define the singular space based on the movement trajectory set, and calculate the movement pattern of the pedestrian in the singular space.

In addition, the control unit 130 may train the trajectory estimation model 121 to estimate the future movement trajectory 12 from the past movement trajectory of the pedestrian based on a predetermined noise distribution using the previously calculated movement pattern.

The output unit 140 may output various information generated by the control unit 130. To this end, the output unit 140 may be connected to a display device that induces a visual stimulus for the user through a wireless or wired network.

Accordingly, the output unit 140 may output information generated in the process of calculating the movement pattern from the movement trajectory of the pedestrian, or may output information generated in the process of training a trajectory estimation model 121 using the movement pattern.

In this regard, the integrated trajectory estimation system according to the present invention may be implemented in a form similar to the integrated trajectory estimation model learning system 100.

For example, the integrated trajectory estimation system may include an input unit, a storage unit, a control unit, and an output unit, and the input unit may receive a predetermined image or the plurality of position coordinates for the pedestrian.

In addition, the storage unit may store instructions and data necessary for the operation of the integrated trajectory estimation system according to the present invention. For example, the storage unit may store the pre-trained trajectory estimation model. In this case, the pre-trained trajectory estimation model may be trained by the integrated trajectory estimation model learning system according to the integrated trajectory estimation model learning method.

In addition, the storage unit may store the image received through the input unit or the plurality of position coordinates. In addition, the storage unit may store the past movement trajectory and the future movement trajectory generated through the control unit.

The control unit may control the overall operation of the integrated trajectory estimation system according to the present invention. For example, when the plurality of images are received through the input unit, the control unit may extract the plurality of position coordinates from each of the plurality of images.

In addition, the control unit may generate the past movement trajectory of the pedestrian based on the plurality of position coordinates, and estimate the future movement trajectory corresponding to the past movement trajectory using the pre-trained trajectory estimation model.

The output unit may output various information generated by the control unit. For example, the output unit may output the plurality of images and the plurality of position coordinates input through the input unit, and may output the past movement trajectory and future movement trajectory of the pedestrian generated through the control unit.

Based on the configuration of the integrated trajectory estimation model learning system 100 discussed above, the integrated trajectory estimation model learning method will be described in more detail below.

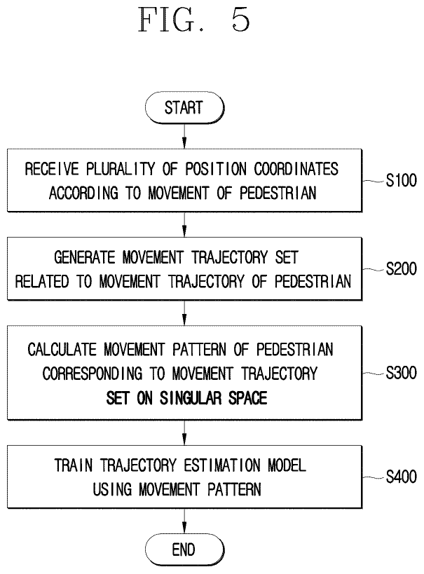

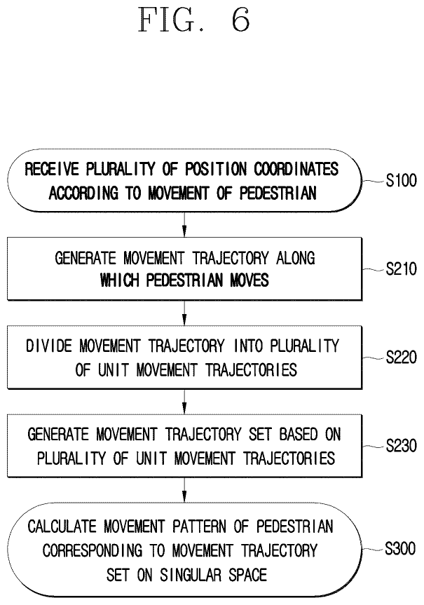

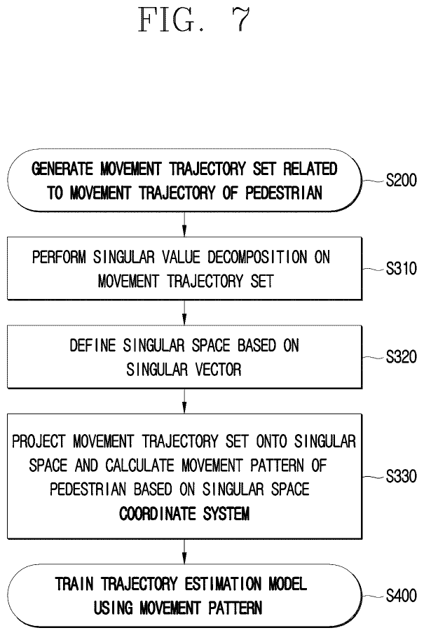

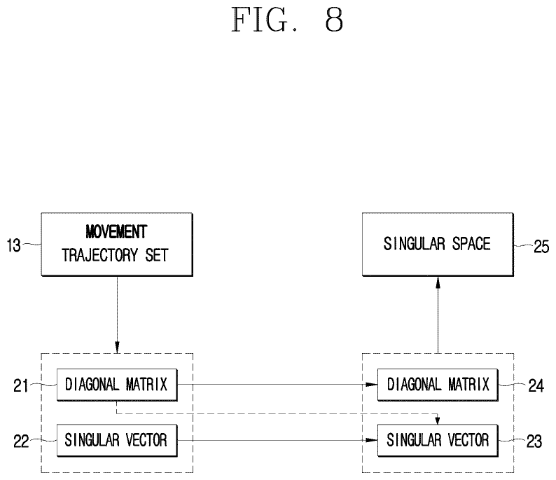

FIG. 5 is a flowchart illustrating the integrated trajectory estimation model learning method according to the present invention. FIG. 6 is a flowchart illustrating a step of generating a movement trajectory set of FIG. 5. FIG. 7 is a flowchart illustrating a step of calculating a movement pattern of FIG. 5. FIG. 8 illustrates one embodiment of defining a singular space.

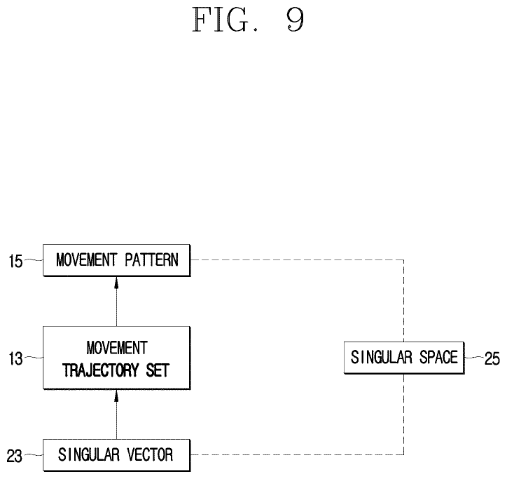

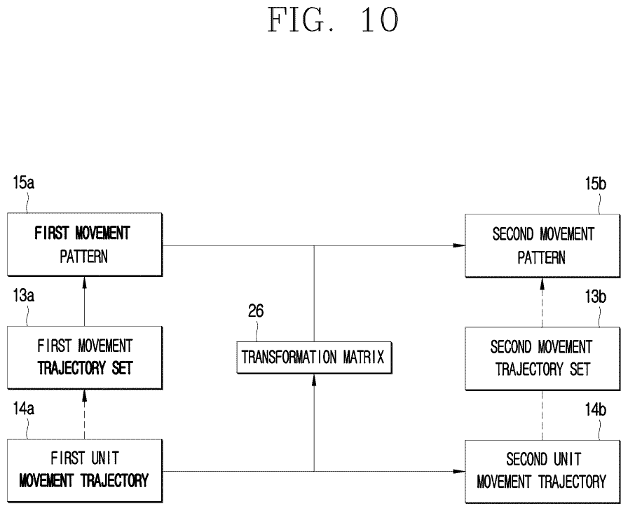

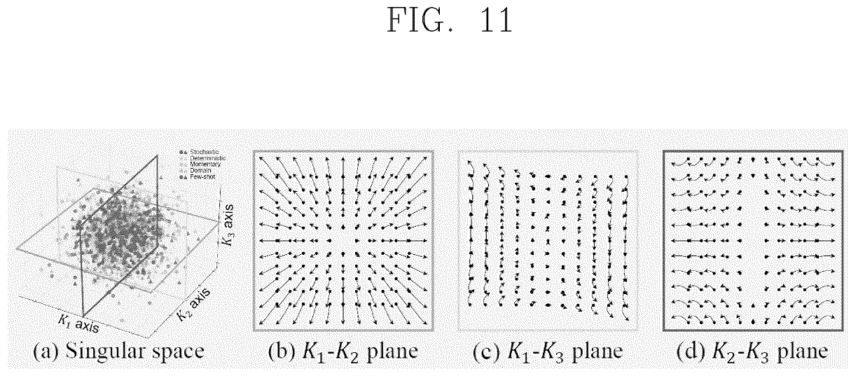

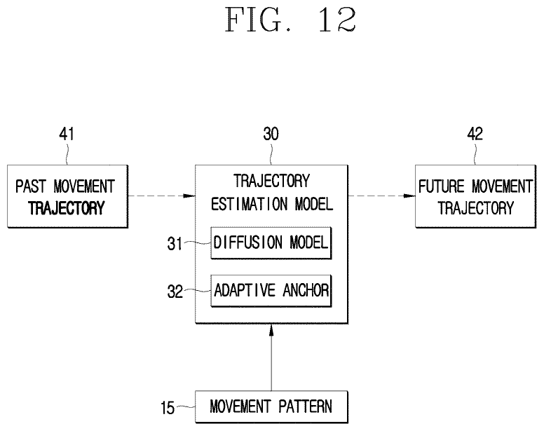

FIG. 9 and FIG. 10 illustrate one embodiment of calculating the movement pattern. FIG. 11 illustrates one embodiment of different movement patterns. FIG. 12 illustrates one embodiment of training a trajectory estimation model.

Referring to FIG. 5, the integrated trajectory estimation model learning system 100 according to the present invention may receive the plurality of position coordinates according to the movement of the pedestrian (S100), and generate the movement trajectory set related to the movement trajectory of the pedestrian based on the plurality of position coordinates (S200).

Specifically, referring to FIG. 6, the integrated trajectory estimation model learning system 100 may receive the plurality of position coordinates along which the pedestrian moves during a predetermined time interval, and generate the movement trajectory along which the pedestrian moves by listing the plurality of received position coordinates in time order (S210).

For example, the integrated trajectory estimation model learning system 100 may receive the plurality of images based on time series data, and extract the position coordinate of the pedestrian from each of the plurality of received images.

Accordingly, the integrated trajectory estimation model learning system 100 may generate the movement trajectory of the pedestrian by listing the plurality of position coordinates extracted from each image based on time series data.

For another example, the integrated trajectory estimation model learning system 100 may receive images (or position coordinates of the pedestrian) from a predetermined device (for example, closed-circuit television (CCTV)) at predetermined time intervals.

Accordingly, the integrated trajectory estimation model learning system 100 may extract the position coordinates of the pedestrian from the received image and list the previously extracted position coordinates according to the time intervals to generate the movement trajectory of the pedestrian.

In this case, the integrated trajectory estimation model learning system 100 may also generate the movement trajectory of the pedestrian based on the plurality of images received during predetermined time intervals.

For another example, the integrated trajectory estimation model learning system 100 may receive a plurality of position coordinates grouped for each of a plurality of different pedestrians.

In this case, the integrated trajectory estimation model learning system 100 may generate the plurality of movement trajectories corresponding to each of the plurality of pedestrians by listing the plurality of position coordinates included in each group in time order.

Furthermore, the integrated trajectory estimation model learning system 100 may divide the previously generated movement trajectory of the pedestrian into the plurality of unit movement trajectories according to a predetermined unit time (S220), and generate the movement trajectory set based on the plurality of divided unit movement trajectories (S230).

For example, the integrated trajectory estimation model learning system 100 may generate the plurality of unit movement trajectories by dividing the movement trajectory in which the plurality of position coordinates are listed previously in time order by each predetermined unit time.

Accordingly, the integrated trajectory estimation model learning system 100 may generate the movement trajectory set including the plurality of unit movement trajectories.

For another example, the integrated trajectory estimation model learning system 100 may divide a video including the plurality of frames into unit frame intervals (for example, 12 frames) so that a predetermined number of frames are included, and extract the position coordinate of the pedestrian from each of the plurality of frames belonging to each of the divided unit frames to generate the unit movement trajectory.

That is, the integrated trajectory estimation model learning system 100 may generate the plurality of unit movement trajectories divided into unit frame intervals, and generate a movement trajectory set using the plurality of unit movement trajectories.

As another example, the integrated trajectory estimation model learning system 100 may divide the plurality of movement trajectories generated for each of the plurality of different pedestrians according to a predetermined unit time to generate the plurality of unit movement trajectories, and may generate the movement trajectory set using the plurality of generated unit movement trajectories.

In this case, the integrated trajectory estimation model learning system 100 may generate the movement trajectory set for each pedestrian, or may generate a single movement trajectory set using the plurality of unit movement trajectories generated for the plurality of pedestrians.

Referring to FIG. 5 again, the integrated trajectory estimation model learning system 100 according to the present invention may define the singular space having the singular space coordinate system based on the movement trajectory set, and may calculate the movement pattern of the pedestrian corresponding to the movement trajectory set on the singular space (S300).

Specifically, referring to FIG. 7, the integrated trajectory estimation model learning system 100 may perform singular value decomposition on the previously generated movement trajectory set (S310) and define the singular space based on the singular vector generated according to the singular value decomposition (S320).

Referring to FIG. 8, for example, the integrated trajectory estimation model learning system 100 may perform the singular value decomposition on a movement trajectory set 13 to calculate a diagonal matrix 21 including the plurality of singular values and a singular vector 22.

Next, the integrated trajectory estimation model learning system 100 may extract a predetermined number (for example, 4) of singular values from among the plurality of singular values included in the diagonal matrix 21 to specify a new diagonal matrix 24, and may correct the singular vector 22 based on the previously extracted singular value so as to correspond to the previously specified new diagonal matrix 24.

In this case, the integrated trajectory estimation model learning system 100 may extract a predetermined number of singular values by repeating the process of removing the singular value corresponding to noise and a duplicated singular value from among the plurality of singular values included in the diagonal matrix 21, and may calculate a new corrected singular vector 23 based on this.

Accordingly, the integrated trajectory estimation model learning system 100 may define a singular space 25 based on the previously calculated singular vector 23.

Furthermore, referring to FIG. 7 again, the integrated trajectory estimation model learning system 100 may project the previously generated movement trajectory set onto the previously defined singular space, and calculate the movement pattern of the pedestrian based on the singular space coordinate system (S330).

Referring to FIG. 9, for example, the integrated trajectory estimation model learning system 100 may use the singular vector 23 calculated based on the movement trajectory set 13 to calculate the coordinates of the movement trajectory set 13 on the singular space 25, and specify the coordinates of the previously calculated movement trajectory set 13 as the movement pattern 15 of the pedestrian projected by the movement trajectory set 13 on the singular space 25.

Referring to FIG. 10, for another example, the integrated trajectory estimation model learning system 100 may use a first movement pattern 15a calculated in advance based on the singular space to calculate a second movement pattern 15b corresponding to a second movement trajectory set 13b that is different from a first movement trajectory set 13a used to calculate the first movement pattern 15a.

In this case, the second movement trajectory set 13b may include a second unit movement trajectory 14b having a different length (or unit time) from a first unit movement trajectory 14a included in the first movement trajectory set 13a.

Therefore, the integrated trajectory estimation model learning system 100 may calculate a transformation matrix 26 based on the length of the first unit movement trajectory 14a and the length of the second unit movement trajectory 14b, and calculate the second movement pattern 15b from the first movement pattern 15a using the calculated transformation matrix 26.

In relation to this, referring to FIG. 11, a singular space an illustrating a plurality of movement patterns corresponding to a diagonal matrix including different singular values may be confirmed. In addition, relationships b, c, and d between the plurality of movement patterns may be confirmed.

This movement pattern can represent a straight trajectory or a rotational trajectory as the trajectory along which the pedestrian moves.

Referring to FIG. 5 again, the integrated trajectory estimation model learning system 100 according to the present invention may train the trajectory estimation model to estimate the future movement trajectory from the past movement trajectory of the pedestrian using the movement pattern calculated based on the singular space (S400).

Specifically, referring to FIG. 12, the integrated trajectory estimation model learning system 100 may train a trajectory estimation model 30 to simulate the previously calculated movement pattern 15 from a predetermined noise distribution through a diffusion model 31.

Through this, the trajectory estimation model 30 may be trained to estimate a future movement trajectory 42 based on the previously calculated movement pattern 15 for an input past movement trajectory 41 when the past movement trajectory 41 for a specific pedestrian is input.

Furthermore, the integrated trajectory estimation model learning system 100 may estimate the walking area in which the pedestrian can move by performing semantic segmentation on a predetermined image through an adaptive anchor 32, and train the trajectory estimation model 30 to move the future movement trajectory 42 estimated through the trajectory estimation model 30 into the walking area.

Through the above configurations, the integrated trajectory estimation model learning system 100 calculates the movement pattern for the motion of the pedestrian based on the movement trajectory of the pedestrian, and trains the trajectory estimation model using the calculated movement pattern. Accordingly, by considering the flow of the trajectory that the pedestrian actually walks, and based on the flow of the trajectory, it is possible to more accurately estimate the future movement trajectory of the pedestrian from the past movement trajectory of the pedestrian.

In addition, the integrated trajectory estimation model learning system 100 projects the movement trajectory of the pedestrian onto the singular space to integrate the movement trajectories of the pedestrian collected in different types into the singular space, and trains the trajectory estimation model based on the integrated singular space. Therefore, it is possible to include training data for the different types of trajectory estimation models in an integrated manner, and estimate accurate the future movement trajectory for the movement trajectory of the pedestrian measured in various types.

Furthermore, the present invention discussed above may be implemented as a program stored on a computer-readable recording medium that is executed by one or more processes in an electronic device.

Therefore, the present invention may be implemented as a computer-readable code or instruction in a medium in which a program is recorded. In other words, various control methods according to the present invention may be provided in the form of an integrated or individual program.

Meanwhile, a computer-readable medium includes all types of recording devices in which data that can be read by a computer system is stored. Examples of computer-readable media include a hard disk drive (HDD), a solid state disk (SSD), a silicon disk drive (SDD), a ROM, a RAM, a CD-ROM, a magnetic tape, a floppy disk, an optical data storage device, or the like.

Furthermore, the computer-readable medium may include a storage and may be a server or cloud storage that the electronic device can access through communication. In this case, the computer can download the program according to the present invention from the server or cloud storage through wired or wireless communication.

Furthermore, in the present invention, the computer described above is an electronic device equipped with a processor, that is, a central processing unit (CPU), and there is no particular limitation on the type thereof.

Meanwhile, the detailed description above should not be construed as restrictive in all aspects and should be considered exemplary. The scope of the present invention should be determined by a reasonable interpretation of the appended claims, and all changes within the equivalent scope of the present invention are included in the scope of the present invention.

What is claimed is:

1. An integrated trajectory estimation method comprising:
receiving a plurality of position coordinates according to a movement of a pedestrian;
generating a past movement trajectory of the pedestrian based on the plurality of position coordinates; and
estimating a future movement trajectory corresponding to the past movement trajectory using a pre-trained trajectory estimation model,
wherein the pre-trained trajectory estimation model is trained according to an integrated trajectory estimation model learning method, and
the integrated trajectory estimation model learning method includes
receiving a plurality of learning position coordinates according to the movement of the pedestrian,
generating a movement trajectory set related to a learning movement trajectory of the pedestrian based on the plurality of learning position coordinates,
defining a singular space having a singular space coordinate system based on the movement trajectory set, and calculating a movement pattern of the pedestrian corresponding to the movement trajectory set on the singular space, and
training the trajectory estimation model by using the movement pattern calculated based on the singular space to estimate the future movement trajectory from the past movement trajectory of an arbitrary pedestrian.

2. An integrated trajectory estimation system comprising:
an input unit configured to receive a plurality of position coordinates according to a movement of a pedestrian; and
a control unit configured to generate a past movement trajectory of the pedestrian based on the plurality of position coordinates and estimate a future movement trajectory corresponding to the past movement trajectory using a pre-trained trajectory estimation model,
wherein the pre-trained trajectory estimation model is trained according to an integrated trajectory estimation model learning method, and
the integrated trajectory estimation model learning method includes
receiving a plurality of learning position coordinates according to the movement of the pedestrian,
generating a movement trajectory set related to a learning movement trajectory of the pedestrian based on the plurality of learning position coordinates,
defining a singular space having a singular space coordinate system based on the movement trajectory set, and calculating a movement pattern of the pedestrian corresponding to the movement trajectory set on the singular space, and
training the trajectory estimation model by using the movement pattern calculated based on the singular space to estimate the future movement trajectory from the past movement trajectory of an arbitrary pedestrian.

3. A program stored on a computer-readable recording medium, and executed by one or more processors in an electronic device, the program including instructions to execute:
receiving a plurality of position coordinates according to a movement of a pedestrian;
generating a past movement trajectory of the pedestrian based on the plurality of position coordinates; and
estimating a future movement trajectory corresponding to the past movement trajectory using a pre-trained trajectory estimation model,
wherein the pre-trained trajectory estimation model is trained according to an integrated trajectory estimation model learning method, and
the integrated trajectory estimation model learning method includes
receiving a plurality of learning position coordinates according to the movement of the pedestrian,
generating a movement trajectory set related to a learning movement trajectory of the pedestrian based on the plurality of learning position coordinates,
defining a singular space having a singular space coordinate system based on the movement trajectory set, and calculating a movement pattern of the pedestrian corresponding to the movement trajectory set on the singular space, and
training the trajectory estimation model by using the movement pattern calculated based on the singular space to estimate the future movement trajectory from the past movement trajectory of an arbitrary pedestrian.

4. An integrated trajectory estimation model learning method comprising:
receiving a plurality of position coordinates according to a movement of a pedestrian;
generating a movement trajectory set related to a movement trajectory of the pedestrian based on the plurality of position coordinates;
defining a singular space having a singular space coordinate system based on the movement trajectory set, and calculating a movement pattern of the pedestrian corresponding to the movement trajectory set on the singular space; and
training the trajectory estimation model by using the movement pattern calculated based on the singular space to estimate a future movement trajectory from a past movement trajectory of an arbitrary pedestrian.

5. The integrated trajectory estimation model learning method of the claim 4, wherein the calculating of the movement pattern of the pedestrian includes
performing singular value decomposition on the movement trajectory set,
defining the singular space based on a singular vector generated according to the singular value decomposition, and
projecting the movement trajectory set onto the singular space and calculating the movement pattern of the pedestrian based on the singular space coordinate system.

6. The integrated trajectory estimation model learning method of the claim 5, wherein the performing of the singular value decomposition includes
performing singular value decomposition on the movement trajectory set, and calculating a diagonal matrix including a plurality of singular values, and the singular vector,
extracting a predetermined number of singular values among the plurality of singular values included in the diagonal matrix, and
correcting the singular vector based on the extracted singular values.

7. The integrated trajectory estimation model learning method of the claim 4, wherein the calculating of the movement pattern of the pedestrian includes calculating, by using a first movement pattern calculated in advance based on the singular space, a second movement pattern corresponding to a second movement trajectory set different from a first movement trajectory set used to calculate the first movement pattern.

8. The integrated trajectory estimation model learning method of the claim 4, wherein the trajectory estimation model is implemented to estimate a walking area from an image corresponding to the plurality of received position coordinates using a pre-equipped semantic segmentation model, and to dispose the future movement trajectory in the walking area.

9. An integrated trajectory estimation model learning system comprising:
an input unit configured to receive a plurality of position coordinates according to a movement of a pedestrian; and
a control unit configured to train a trajectory estimation model to estimate a future movement trajectory from a past movement trajectory of an arbitrary pedestrian based on the plurality of position coordinates,
wherein the control unit generates a movement trajectory set related to the movement trajectory of the pedestrian based on the plurality of position coordinates, defines a singular space having a singular space coordinate system based on the movement trajectory set, calculates a movement pattern of the pedestrian corresponding to the movement trajectory set on the singular space, and trains the trajectory estimation model using the movement pattern calculated based on the singular space.

10. A program stored on a computer-readable recording medium, and executed by one or more processors in an electronic device, the program including instructions to execute:
receiving a plurality of position coordinates according to a movement of a pedestrian;
generating a movement trajectory set related to a movement trajectory of the pedestrian based on the plurality of position coordinates,
defining a singular space having a singular space coordinate system based on the movement trajectory set, and calculating a movement pattern of the pedestrian corresponding to the movement trajectory set on the singular space, and
training the trajectory estimation model by using the movement pattern calculated based on the singular space to estimate a future movement trajectory from a past movement trajectory of an arbitrary pedestrian.
